(19) United States
(12) Patent Application Publication
(10) Pub. No.: US 2017/0258250 A1
(43) Pub. Date: Sep. 14, 2017

(54) MEASURED FOOD STORAGE APPARATUS

(71) Applicant: JULIAN GAINE, London (GB)

(72) Inventor: JULIAN GAINE, London (GB)

(21) Appl. No.: 15/456,089

(22) Filed: Mar. 10, 2017

(30) Foreign Application Priority Data
Mar. 11, 2016 (GB) 1604193.1

(51) Int. Cl. A47G 19/02; B65D 25/04; B65D 25/24; G01F 19/00; B65D 43/02

(52) U.S. Cl. CPC A47G 19/025; G01F 19/002; B65D 43/02; B65D 25/24; B65D 25/04

(57) ABSTRACT

A measured food storage apparatus comprising a base portion having at least two defined sections for receiving specified contents, at least one of said sections being configured to removably receive a decanting device. The decanting device has a base and at least one outer side wall, defining a receptacle for receiving specified contents. In use, when said decanting device is releasably attached to said base portion of the measured food storage apparatus, the at least one side wall thereof defines a compartment on said base portion.

This invention relates to an apparatus for measured food storage, particularly, but not necessarily exclusively, for measuring and storing a daily food allowance of a user in accordance with their dieting goals.

It is common for people trying to regulate their body weight to measure out portion sizes for each meal that they prepare to ensure that they are consuming the correct quantities of each food group to attain their dieting goals. This is commonly done using scales to measure out the specific weight of each food group, including fats, carbohydrates and proteins, in accordance with a pre-set regime to assist the individual with gaining, losing or maintaining their current body weight. However, this repeated measuring and calculating can be time consuming and complicated, making it more difficult for an individual to stick to their diet regime.

As such, there exist a number of measuring devices in the prior art that assist users with measuring and maintaining their advised daily dietary intake. For example, Utility Model number CN204246281 describes a diet measuring instrument for gestational diabetes mellitus gravida comprising a box body and lid, the body being divided into staple food compartments by partition plates which may be moved to alter the size of the compartments. However, it can be difficult and time consuming for the user to transfer the food directly from the box to their plate or preparation location with this set-up.

U.S. Pat. No. 5,007,743 describes a dish with a continuous surrounding wall defining an interior cavity including first and second concave recesses for receiving metered containers therein and selectively movable partition walls for controlling portions of the respective food groups. However, as with the previous prior art apparatus, it can be difficult and time consuming for the user to transfer the food directly from the partitioned recesses within this dish to their plate or preparation location. Furthermore, there is no means for securing the metered containers within the concave recesses of this assembly meaning that they can be easily misplaced when not in use and displaced during transport of the box.

It would, therefore, be desirable to produce a measured food storage apparatus with separate compartments for individual staple food types, which is stable and efficient to use so that food can be transferred directly from the apparatus to the desired preparation location. Aspects of the present invention seek to address at least some of these issues.

In accordance with an aspect of the present invention, there is provided a measured food storage apparatus comprising a non-compartmented base portion having at least two defined sections for receiving specified contents, at least one of said sections being configured to removably receive a decanting device, the decanting device having a base and at least one outer side wall defining a receptacle for receiving one of said specified contents, the base of the decanting device being releasably attachable to the base portion of the food storage apparatus, such that, in use, when said decanting device is releasably attached to said base portion of the measured food storage apparatus the at least one side wall thereof defines a compartment on said base portion.

In an exemplary embodiment of the invention, the base portion may comprise a defined section for receiving fats which is configured to removably receive a decanting device. The base portion may also comprise a defined section for receiving proteins which is configured to removably receive a decanting device. The base portion may further comprise a defined section for receiving carbohydrates which is configured to removably receive a decanting device.

According to another exemplary embodiment of the invention, the at least one section of the base portion configured to receive a decanting device may comprise at least one releasable attachment means.

According to a further exemplary embodiment of the present invention, the at least one section of the base portion configured to receive a decanting device may comprise at least two interspaced releasable attachment means. The decanting device may be releasably attachable to the at least two interspaced releasable attachment means on the at least one section of the base portion, the position of the decanting device defining the size of the compartment.

The decanting device may also comprise at least one releasable attachment means on the base thereof. This releasable attachment means on the base of the decanting device may be configured to releasably mate with said at least one releasable attachment means on the at least one section the base portion of the measured food storage apparatus.

According to an exemplary embodiment of the present invention, the releasable attachment means on the at least one section of the base portion configured to receive a decanting device may be a recessed groove and the releasable attachment means on the base of the decanting device may be a substantially downward protrusion shaped and configured to mate with the recessed groove.

Optionally, the releasable attachment means on the at least one section of the base portion configured to receive a decanting device may be a substantially upward protrusion and the releasable attachment means on the base of the decanting device may be a recessed groove shaped and configured to mate with the upward protrusion. Alternatively, the releasable attachment means on the at least one section of the base portion configured to receive a decanting device and on the decanting device may be a hook and loop fastener. The measured food storage apparatus may also comprise at least one foot portion on the base thereof. This at least one foot portion may be composed of rubber.

There may be provided a scale indicating the position of at least one fill level on at least one side wall of the decanting device. There also may be provided a scale indicating the position of at least two fill levels on at least one side wall of the decanting device.

In an exemplary embodiment of the present invention, the measured food storage apparatus may be composed of a lightweight, durable material, for example, plastic.

In a further aspect of the present invention, the measured food storage apparatus may further comprise at least one compartmented base portion having at least one defined section, said at least one defined section being configured to removably receive a container, the container having a base and at least one outer side wall defining a recess for receiving specified contents.

According to another aspect of the present invention, there is provided a decanting device for the measured food storage apparatus described above, the decanting device having a base and at least one outer side wall defining a receptacle, the base of the decanting device being releasably attachable to said base portion of the food storage apparatus, such that, in use, when said decanting device is releasably attached to said base portion of the measured food storage apparatus the at least one side wall thereof defines a compartment on said base portion.

Whilst the invention has been described above, it extends to any inventive combination of the features set out above, or in the following description. Other aspects of the present invention will be apparent to a person skilled in the art from the following description in which embodiments of the present invention are described, by way of examples only, and with reference to the accompanying drawings, in which:

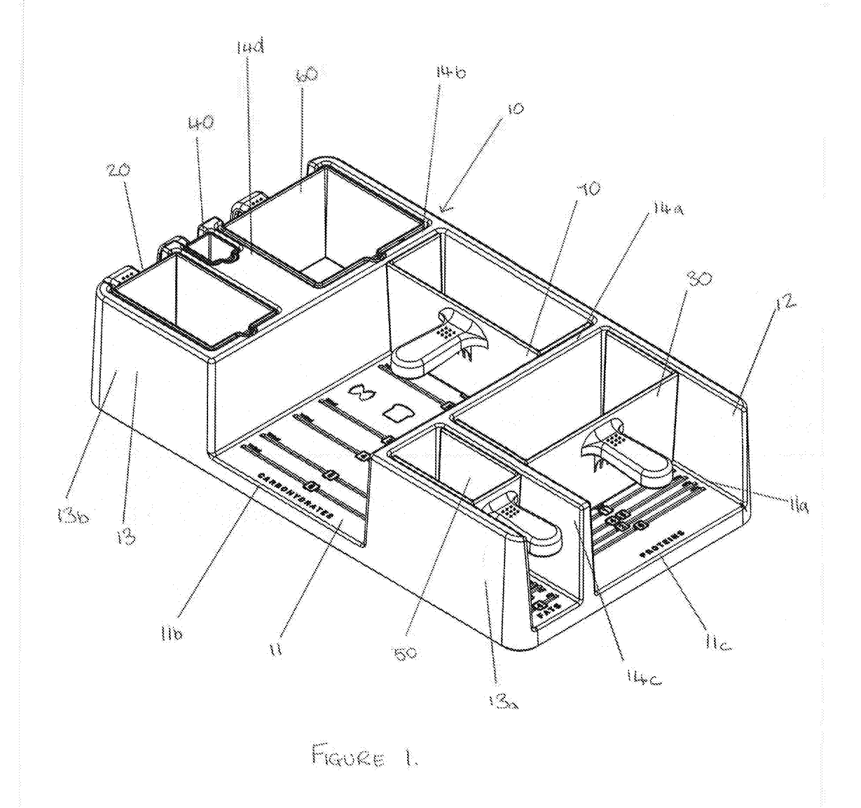

FIG. 1 is a schematic front perspective view of a measured food storage apparatus according to an exemplary embodiment of the present invention;

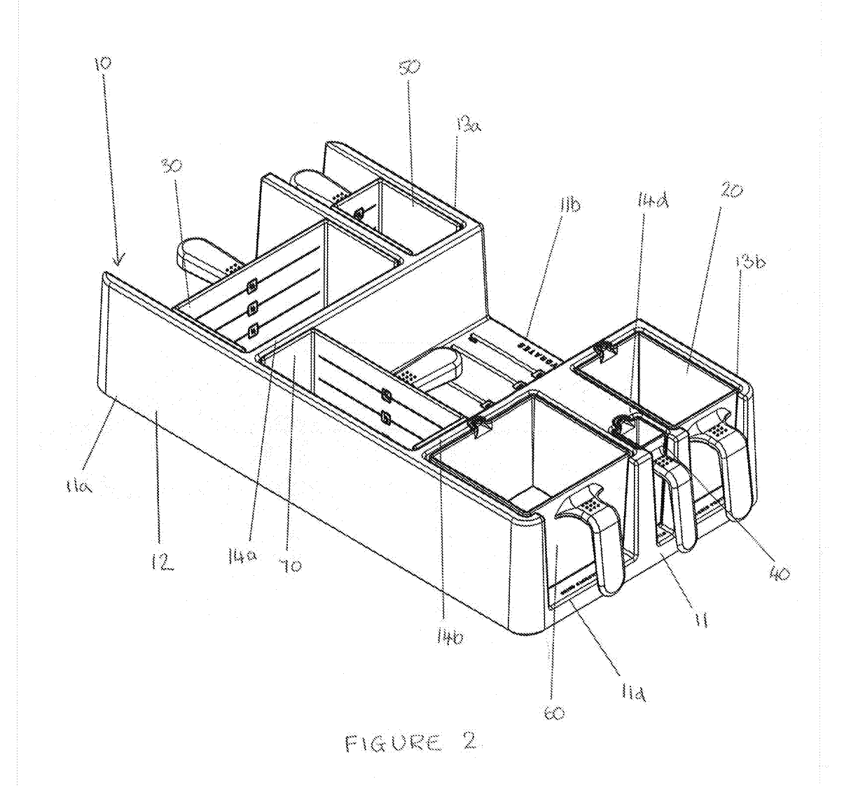

FIG. 2 is a schematic rear perspective view of the measured food storage apparatus of FIG. 1;

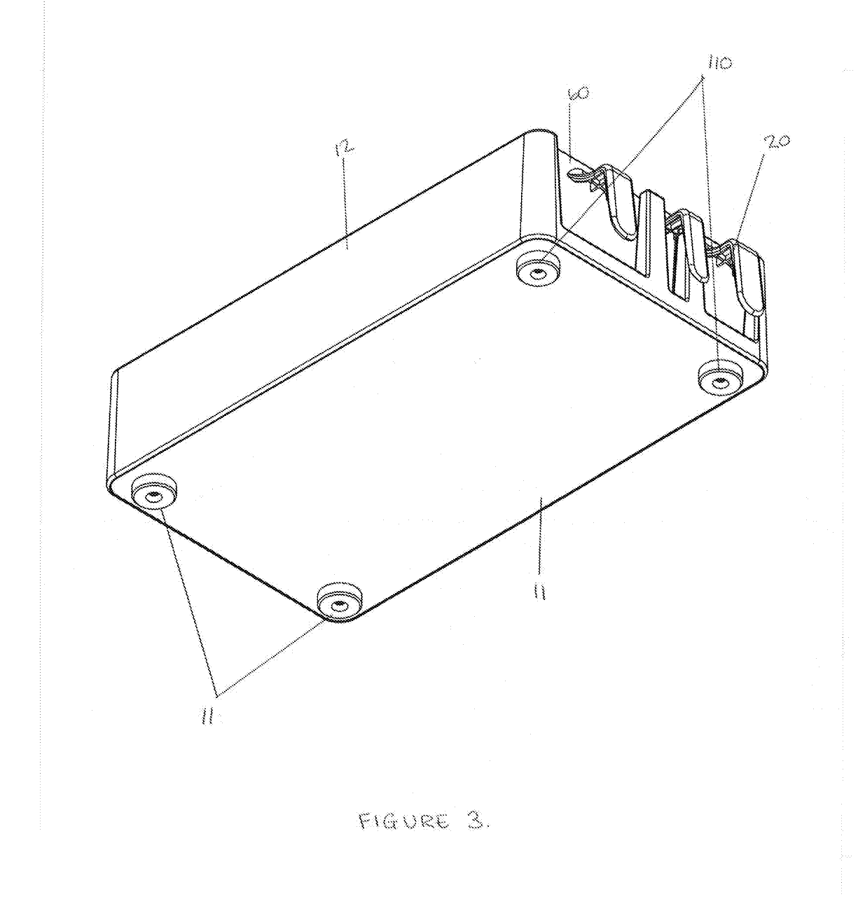

FIG. 3 is a schematic base perspective view of the measured food storage apparatus of FIG. 1;

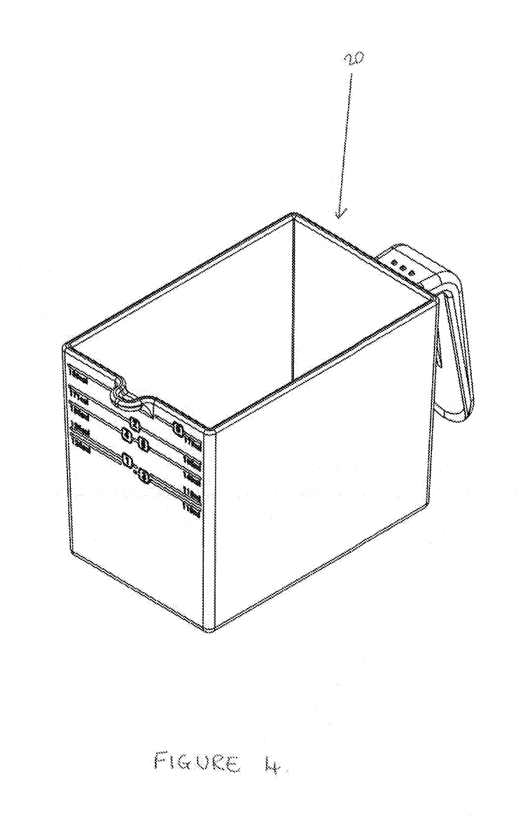

FIG. 4 is a schematic front perspective view of a removable liquid proteins jug component of the measured food storage apparatus of FIG. 1;

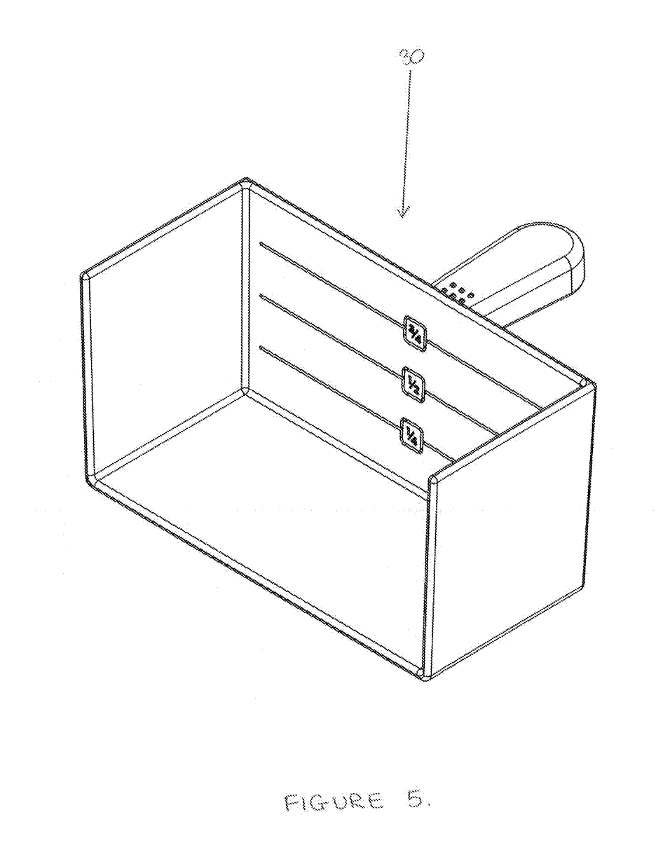

FIG. 5 is a schematic front perspective view of a removable solid proteins scoop component of the measured food storage apparatus of FIG. 1;

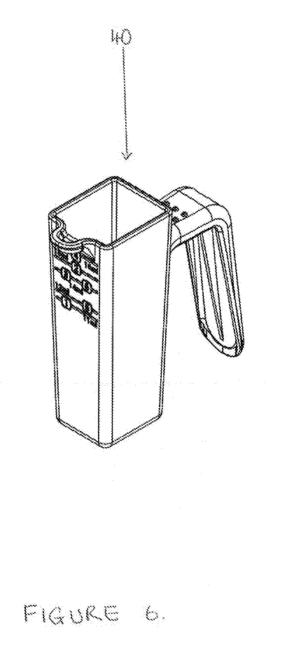

FIG. 6 is a schematic front perspective view of a removable liquid fats jug component of the measured food storage apparatus of FIG. 1;

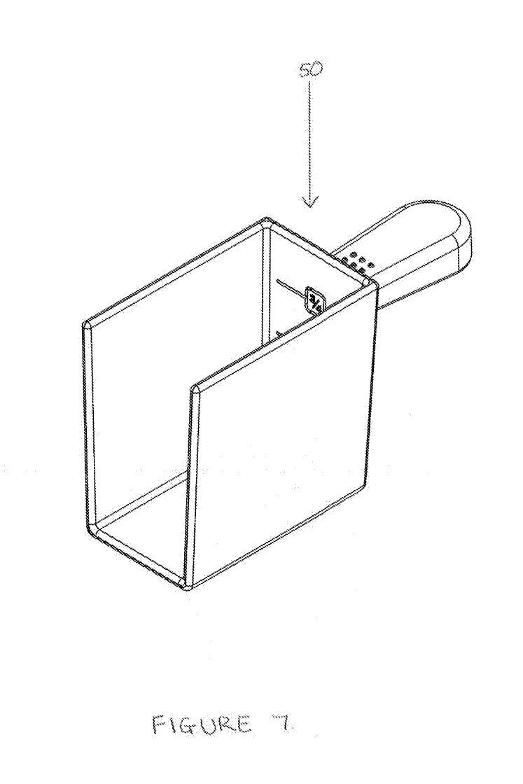

FIG. 7 is a schematic front perspective view of a removable solid fats scoop component of the measured food storage apparatus of FIG. 1;

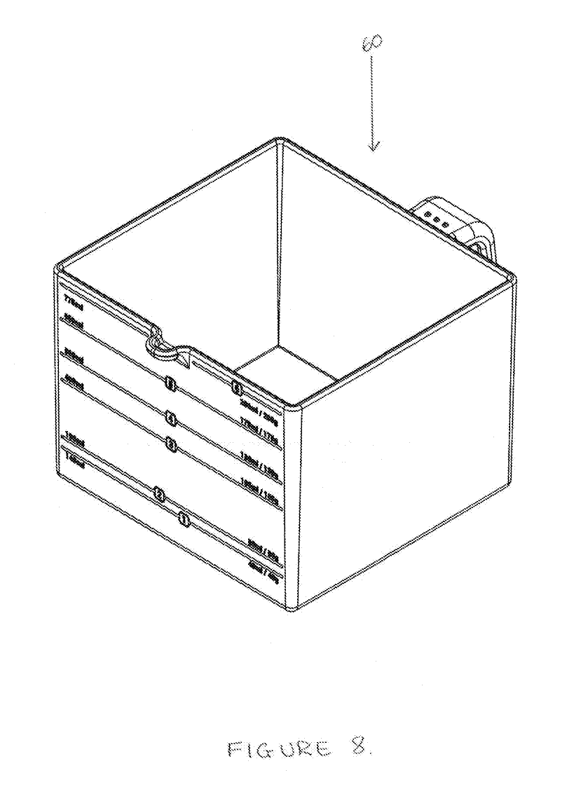

FIG. 8 is a schematic front perspective view of a removable dried carbohydrates jug component of the measured food storage apparatus of FIG. 1;

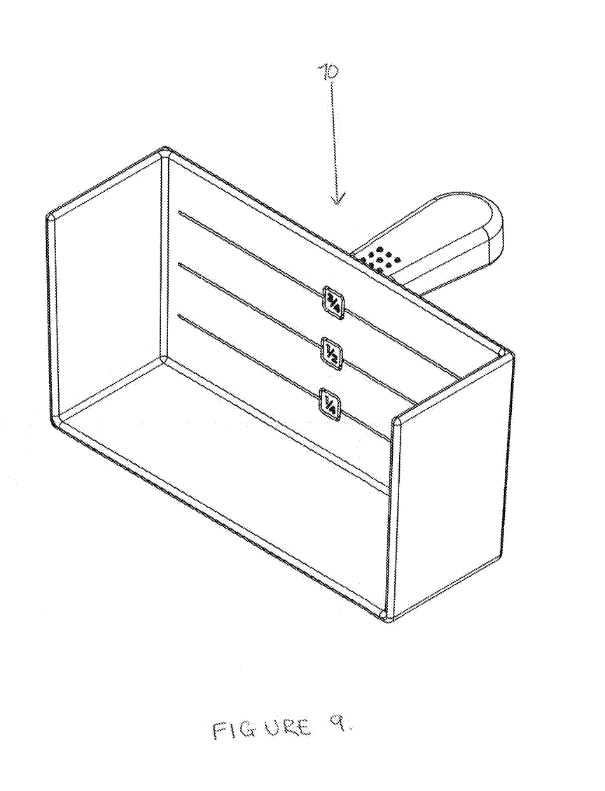

FIG. 9 is a schematic front perspective view of a removable solid carbohydrates scoop component of the measured food storage apparatus of FIG. 1;

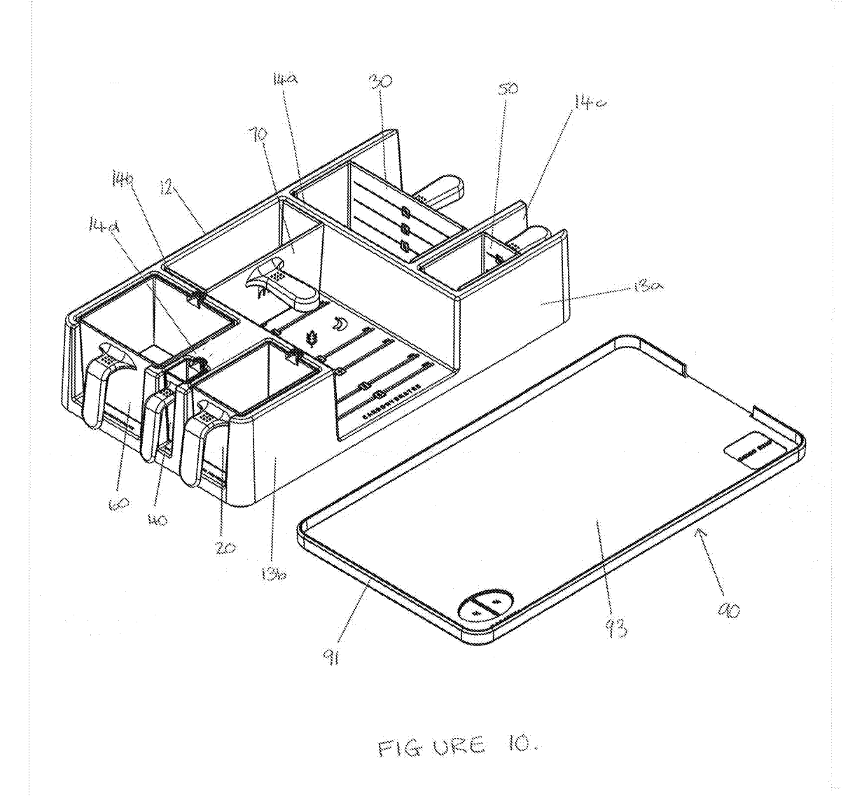

FIG. 10 is a schematic side perspective view of a the measured food storage apparatus of FIG. 1, with a lid;

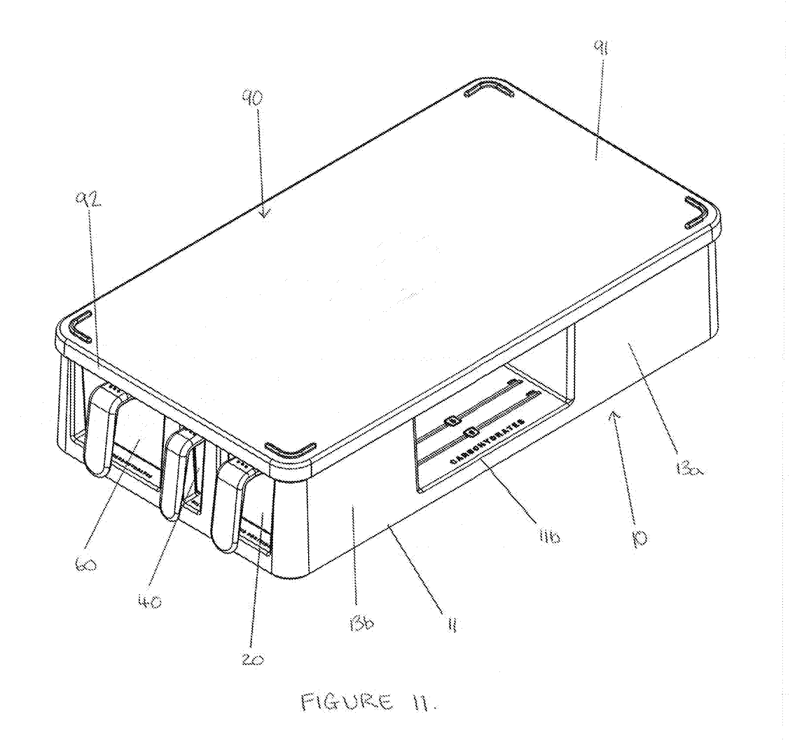

FIG. 11 is a schematic side perspective view of the measured food storage apparatus of FIG. 1, with the lid of FIG. 10, in its fully assembled configuration.

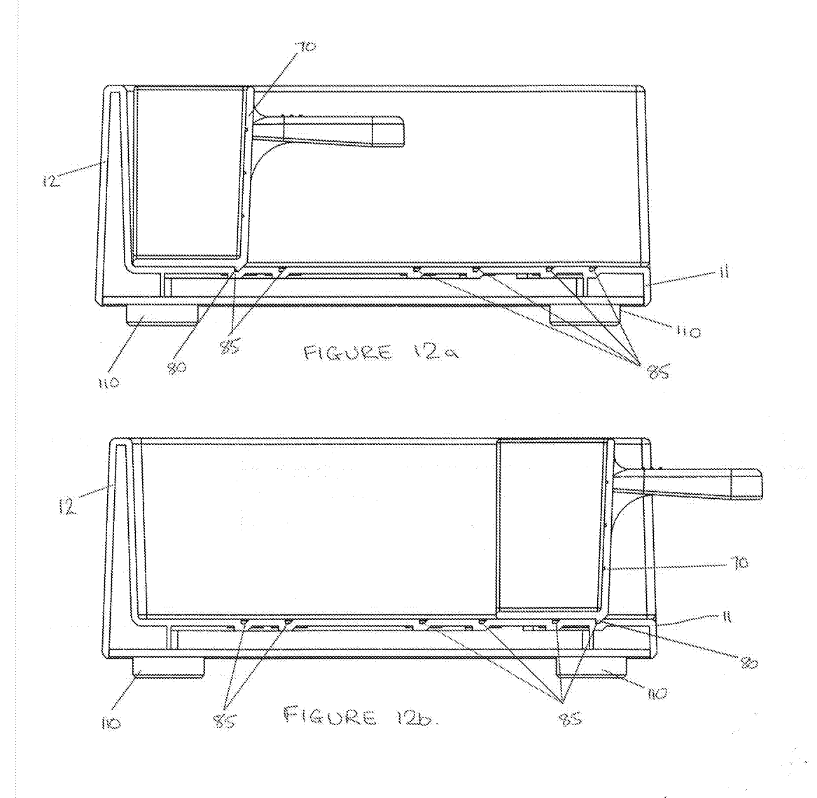

FIG. 12a is a schematic cross-sectional side view of the measured food storage apparatus of FIG. 1, with the solid carbohydrates scoop component of FIG. 9 and the lid of FIG. 10;

FIG. 12b is a schematic cross-sectional side view of the measured food storage apparatus of FIG. 1 with the solid carbohydrates scoop component of FIG. 9 and the lid of FIG. 10;

Referring to FIG. 1 of the drawings, a measured food storage apparatus 1 according to an exemplary embodiment of the present invention comprises a main body element 10, a liquid proteins jug 20, a solid proteins scoop 30, a liquid fats jug 40, a solid fats scoop 50, a dried carbohydrates jug 60 and a solid carbohydrates scoop 70. Each component of the measured food storage apparatus 1 is formed of a lightweight, durable material such as food safe plastic.

The main body element 10 has a substantially rectangular cross-section and is composed of a single piece of moulded plastic comprising a substantially flat base 11, a rear face 12, a front face 13 and a plurality of interconnecting partitioning walls 14a-14d. The flat base 11 of the main body element 10 is configured to lie substantially parallel to the surface on which it rests, with each of the walls 12 to 14d extending substantially vertically upwards from the upper surface of the base 11.

The rear face 12 is formed of a single, elongate wall traversing the rear lengthwise edge 11a of the base 11. The front face 13 is formed of two walls positioned on the left (L-front wall 13b) and right (R-front wall 13a) outermost portions the front lengthwise edge 11b of the base 11, with a substantially central, rectangular opening therebetween. Extending perpendicularly from the rear face 12 to the front face 13 are two partitioning walls 14a and 14b which traverse the width of the base 11. The two partitioning walls 14a and 14b define the substantially central, rectangular opening in the front face 13, the opening extending therebetween to the rear face 12. This opening is therefore substantially cuboidal in nature and forms the “solid carbohydrates” section of the measured food storage apparatus 1. The base 11 of this section is labelled “Carbohydrates”.

On the external face of the partitioning wall 14a, i.e. on the right hand side of the measured food storage apparatus 1 when viewed from the front face 13, the gap between the R-front wall 13a and the rear face 12 is divided in two by a further partitioning wall 14c. The partitioning wall 14c is positioned roughly one quarter of the way from the R-front wall 13a to the rear face 12, extending substantially perpendicularly from the external face of the partitioning wall 14a to the right widthwise edge 11c of the base 11, meaning that it is substantially parallel to both the R-front wall 13a and the rear face 12. The opening between the front face 13 and the partitioning wall 14c is substantially cuboidal in nature and forms the “solid fats” section of the measured food storage apparatus 1. The base 11 of this section is labelled “Fats”. The opening between the partitioning wall 14c and the rear face 12 is also substantially cuboidal in nature and forms the “solid proteins” section of the measured food storage apparatus 1. The base 11 of this section is labelled “Proteins”.

On the external face of the partitioning wall 14b, i.e. on the left hand side of the measured food storage apparatus 1 when viewed from the front face 13, the gap between the L-front wall 13b and the rear face 12 is divided in two by a further partitioning wall 14d. The partitioning wall 14d is positioned roughly one third of the way from the L-front wall 13b to the rear face 12, extending substantially perpendicularly from the partitioning wall 14b, meaning that it is substantially parallel to both the L-front wall 13b and the rear face 12. The partitioning wall 14d has a relatively wide diameter, and as such, it can accommodate an opening roughly one third of the way from the external edge thereof. The partitioning wall 14d continues to extend either side of the opening to the left widthwise edge 11d of the base 11, where both sides of the partitioning wall 14d form a substantially perpendicular curve to face inwards towards each other. The opening within the partitioning wall 14d is roughly cuboidal in nature and forms the “liquid fats” section of the measured food storage apparatus 1. The base 11 of this section is labelled “Oils”.

Both the L-front wall 13b and the partitioning wall 14d form a substantially perpendicular curve at the left widthwise edge 11d of the base 11 to face inwards towards each other. The opening between the L-front wall 13b and the partitioning wall 14d is substantially cuboidal in nature and forms the “liquid proteins” section of the measured food storage apparatus 1. The base 11 of this section is labelled “Liquid Proteins”. Both the partitioning wall 14d and the rear face 12 also form a substantially perpendicular curve at the left widthwise edge 11d of the base 11 to face inwards towards each other. The opening between the partitioning wall 14d and the rear face 12 is also substantially cuboidal in nature and forms the “dried carbohydrates” section of the measured food storage apparatus 1. The base 11 of this section is labelled “Dried Carbohydrates”.

As shown in FIG. 3 of the drawings, the underside of the base 11 of the measured food storage apparatus 1 has four hollow, substantially cylindrical feet 110 extending therefrom. Each of the feet 110 is positioned at a corner of the underside of the base 11, indented from the external edge thereof, to provide stability to the measured food storage apparatus 1 when it is placed on an uneven surface. Each of the feet 110 is formed of a resilient, anti-slip material, such as rubber, that can grip the surface on which it is placed, preventing the measured food storage apparatus 1 from moving during use, for example, if knocked by the user.

Referring to FIGS. 4, 6 and 8 of the drawings, the liquid proteins jug 20, the liquid fats jug 40 and the dried carbohydrates jug 60 all comprise a substantially rectangular base and four side walls of substantially the same height as the walls of the main body element 10, each of which extends substantially vertically upwards from the outermost edge of the base with which they join to define a receptacle for receiving their respective food types. The liquid proteins jug 20 is shaped and configured to receive, measure and store liquid proteins, such as eggs, yoghurt, milk and cottage cheese. The liquid fats jug 40 is shaped and configured to receive, measure and store liquid fats, such as vegetable oil or olive oil and the dried carbohydrates jug 60 is shaped and configured to receive, measure and store dried carbohydrates that may expand in water, such as rice, quinoa and oats.

The liquid proteins jug 20 is shaped and configured to fit within the “liquid proteins” section of the main body element 10, with the curved ends of the L-front wall 13b and the partitioning wall 14d partially enclosing the opening therebetween at the left widthwise edge 11d of the base 11. This means that the liquid proteins jug 20 has to be inserted into the “liquid proteins” section from above as the opening at the left widthwise edge 11d of the base 11 is not wide enough to accommodate it. However, this provides the advantage of retaining the liquid proteins jug 20 in the “liquid proteins” section unless it is lifted substantially vertically upwards by the user, preventing it from falling or otherwise moving in a way that could cause the contents to spill when in use.

Both the liquid fats jug 40 and the dried carbohydrates jug 60 are retained within the “liquid fats” section and the “dried carbohydrates” section respectively, in the same way. The liquid fats jug 40 is shaped and configured to fit within the “liquid fats” section of the main body element 10, with the curved ends of the partitioning wall 14d retaining the liquid fats jug 40 in the “liquid fats” section, preventing it from falling or otherwise moving in a way that could cause the contents to spill when in use. The dried carbohydrates jug 60 is shaped and configured to fit within the “dried carbohydrates” section of the main body element 10, with the curved ends of the rear face 12 and the partitioning wall 14d retaining the dried carbohydrates jug 60 in the “dried carbohydrates” section, preventing it from falling or otherwise moving in a way that could cause the contents to spill when in use.

Each jug also has a handle affixed to the external face one of its four side walls, the handle being substantially L-shaped, extending perpendicular to the side wall to which it is affixed prior to bending to extend substantially parallel to the side wall to which it is affixed. Each handle is reinforced on the lower surface thereof with a pair of struts arranged in a substantially cross-like formation. The first strut is affixed to both the side wall jug and the base of the handle at the join therebetween narrowing to a point near the distal end of the handle, relative to the jug. The second strut is located toward the proximal end of the handle relative to the jug and horizontally traverses the width of the handle. The struts provide extra strength to the handle of the jug so that it does not distort or snap when the user is transporting the jug filled with food. The opposing side wall of each of the jugs includes a lip on the uppermost edge thereof to improve the accuracy of pouring when transferring the contents of the jug to the relevant kitchen utensil for preparation. The same side wall as the lip also includes a measuring indica on the external face thereof, with multiple horizontal lines labelled with the volume and/or weight and the corresponding calorie content of each food type if the jug were filled up to that respective line. Each jug is formed of a transparent material so that the user can easily measure the correct quantity and corresponding calorie content of the food they are to consume by filling the jug up to the appropriate horizontal line.

Referring to FIGS. 5, 7 and 9 of the drawings, the solid proteins scoop 30, the solid fats scoop 50 and the solid carbohydrates scoop 70 all comprise a substantially rectangular base and three side walls of substantially the same height as the walls of the main body element 10, each of which extends substantially vertically upwards from the outermost edge of the base with which they join. There is no side wall connected to the fourth edge of the base, leaving this face open. The solid proteins scoop 30 is shaped and configured to fit within the “solid proteins” section of the main body element 10 to form a compartment that is shaped and configured to receive, measure and store solid proteins such as meat, fish and cheese. The solid fats scoop 50 is shaped and configured to fit within the “solid fats” section of the main body element 10 to form a compartment that is shaped and configured to receive, measure and store solid fats, such as butter. The solid carbohydrates scoop 70 is shaped and configured to fit within the “solid carbohydrates” section of the main body element 10 to form a compartment that is shaped and configured to receive, measure and store solid carbohydrates, such as bread and pasta.

Each scoop also has a handle affixed to the external face of the side wall opposing the open face of the scoop, the handle being substantially planar, extending perpendicular to the side wall to which it is affixed. Each handle is reinforced on the lower surface thereof with a pair of struts arranged in a substantially cross-like formation. The first strut is affixed to both the side wall of the scoop and the base of the handle at the join therebetween narrowing to a point near the distal end of the handle, relative to the scoop. The second strut is located toward the proximal end of the handle relative to the scoop and horizontally traverses the width of the handle. The struts provide extra strength to the handle of the scoop so that it does not distort or snap when the user is transporting the scoop filled with food. The internal face of the side wall opposing the open face of the scoops includes a measuring indica thereon, with horizontal lines labelling each quarter volume of the scoop. This enables the user to measure the quantity of solid food that they consume according to a pre-set regime.

Referring to FIGS. 1, 12a and 12b of the drawings, each of the ‘solid proteins’, ‘solid fats’ and ‘solid carbohydrates’ sections of the measured food storage apparatus 1 have a plurality of interspaced linear recessed grooves 85 extending across the upper surface of the base 11 of the respective section, parallel to the respective edge of the base 11 that forms the open front face of that section. The solid proteins scoop 30, the solid fats scoop 50 and the solid carbohydrates scoop 70 all comprise a corresponding elongate protrusion 80 extending across the edge of the base opposing the open face thereof that can releasably interlock with each of the linear recesses 85 in the respective section when the measured food storage apparatus 1 is in-use. The linear recess 85 with which the elongate protrusion 80 on each of the scoops 30, 50 and 70 releasably interlocks determines the size of the respective compartment and thus may be varied according to the dietary requirements of the user. For example, if the user wanted to lose weight, they would interlock the elongate protrusion 80 of the scoop with a linear recess 85 further from the respective edge of the base 11 that forms the open front face of that section, to define a smaller compartment within which to measure the respective food type. Conversely, if the same user wanted to gain weight, they would interlock the elongate protrusion 80 of the scoop with a linear recess 85 closer to the respective edge of the base 11 that forms the open front face of that section, to define a larger compartment within which to measure the respective food type. This can be done in accordance with a pre-set regime.

Each linear recessed groove 85 on the base 11 of the main body element 10 is labelled with the weight and the corresponding calorie content that the portion of each food type would contain if the corresponding scoop was filled and positioned so that the elongate protrusion 80 interlocked with that linear recess. This enables the user to accurately measure their portions of each food type directly into the measured food storage apparatus 1 without the scoop moving and without any danger of the scoop tipping over. When the user wants to remove their food from the measured food storage apparatus 1, they can simply un-lock the elongate protrusion 80 on the relevant scoop from the respective linear recessed groove 85 in the base 11 and use the scoop to directly transfer their food to be prepared.

Referring to FIG. 11 of the drawings, the measured food storage apparatus 1 is also provided with a lid 90 comprising a planar, substantially rectangular upper surface 91 and a lip 92 extending substantially downward therefrom to cover the upper surface of the main body element 10 and the food containers, protecting the food from cross contamination when it is being stored in the measured food storage apparatus 1. The upper surface 91 of the lid 90 can also be used as a preparation board and is formed of an easily wipeable material such as food safe plastic. All of the side walls of the component scoops and jugs are substantially the same height as the walls 12 to 14d of the main body element 10, providing a substantially level surface for the lower surface 93 of the lid 90 to rest upon during use, increasing the stability of the lid 90 when it is used as a preparation board. The measured food storage apparatus 1 is relatively lightweight and compact with a substantially cuboid shape making it suitable for storage as a single apparatus when in use, for example, when the users daily food allowance has been measured, it can be stored in a fridge or cupboard. Similarly, this regular shape increases the efficiency of storage when the measured food storage apparatus 1 when it is not in use, without the user having to separate the parts and potentially misplace them.

The measured food storage apparatus 1 can be used to measure and store the user's daily intake of fats, carbohydrates and proteins according to a pre-set regime in accordance with their dieting goals. Each of the component food containers is independently removable so that the user can easily transfer the contents therein to a preparation location when they want to prepare a meal or snack.

It will be apparent to a person skilled in the art, from the foregoing description, that modifications and variations can be made to the described embodiments without departing from the scope of the invention as defined in the appended claims.

1. A measured food storage apparatus comprising a non-compartmented base portion having at least two defined sections for receiving specified contents, wherein:
at least one of said sections being configured to removably receive a decanting device,
the decanting device having a base and at least one outer side wall defining a receptacle for receiving one of said specified contents, and
the base of the decanting device being releasably attachable to the base portion of the food storage apparatus, such that, in use, when said decanting device is releasably attached to said base portion of the measured food storage apparatus the at least one side wall thereof defines a compartment on said base portion.

2. A measured food storage apparatus according to claim 1, wherein said base portion comprises a defined section for receiving fats.

3. A measured food storage apparatus according to claim 2, wherein said defined section for receiving fats is configured to removably receive a decanting device.

4. A measured food storage apparatus according to claim 1, wherein said base portion comprises a defined section for receiving proteins.

5. A measured food storage apparatus according to claim 4, wherein said defined section for receiving proteins is configured to removably receive a decanting device.

6. A measured food storage apparatus according to claim 1, wherein said base portion comprises a defined section for receiving carbohydrates.

7. A measured food storage apparatus according to claim 6, wherein said defined section for receiving carbohydrates is configured to removably receive a decanting device.

8. A measured food storage apparatus according to claim 1, wherein said at least one section of the base portion configured to receive a decanting device comprises at least one releasable attachment means, or said at least one section of the base portion configured to receive a decanting device comprises at least two interspaced releasable attachment means.

9. (canceled)

10. A measured food storage apparatus according to claim 8, wherein said decanting device is releasably attachable to the at least two interspaced releasable attachment means on the at least one section of the base portion, the position of the decanting device defining the size of the compartment.

11. A measured food storage apparatus according to claim 1, wherein said decanting device comprises at least one releasable attachment means on the base thereof.

12. A measured food storage apparatus according to claim 11, wherein said releasable attachment means on the base of the decanting device is configured to releasably mate with said at least one releasable attachment means on the at least one section the base portion of the measured food storage apparatus.

13. A measured food storage apparatus according to claim 12, wherein the releasable attachment means on the at least one section of the base portion configured to receive a decanting device is a recessed groove and the releasable attachment means on the base of the decanting device is a substantially downward protrusion shaped and configured to mate with the recessed groove.

14. A measured food storage apparatus according to claim 12, wherein the releasable attachment means on the at least one section of the base portion configured to receive a decanting device is a substantially upward protrusion and the releasable attachment means on the base of the decanting device is a recessed groove shaped and configured to mate with the upward protrusion.

15. A measured food storage apparatus according to claim 12, wherein the releasable attachment means on the at least one section of the base portion configured to receive a decanting device and on the decanting device is a hook and loop fastener.

16. A measured food storage apparatus according to claim 1, wherein the measured food storage apparatus further comprises at least one foot portion on the base thereof.

17. A measured food storage apparatus according to claim 16, wherein the at least one foot potion is composed of rubber.

18. A measured food storage apparatus according to claim 1, wherein:
the at least one side wall of said decanting device includes a scale indicating the position of at least one fill level,
the at least one side wall of the decanting device includes a scale indicating the position of at least two fill levels, and/or
the measured food storage apparatus is composed of a lightweight, durable material.

19. (canceled)

20. (canceled)

21. A measured food storage apparatus according to claim 18,
wherein the measured food storage apparatus is composed of plastic.

22. A measured food storage apparatus according to claim 1, wherein:
said measured food storage apparatus further comprises at least one compartmented base portion having at least one defined section,
said at least one defined section being configured to removably receive a container, and
the container having a base and at least one outer side wall defining a recess for receiving specified contents.

23. (canceled)

24. A decanting device for the measured food storage apparatus of claim 1, wherein:
the decanting device having a base and at least one outer side wall defining a receptacle, and
the base of the decanting device being releasably attachable to said base portion of the food storage apparatus, such that, in use, when said decanting device is releasably attached to said base portion of the measured food storage apparatus the at least one side wall thereof defines a compartment on said base portion.

25. (canceled)
